(19) United States
(12) Patent Application Publication
(10) Pub. No.: US 2024/0031171 A1
(43) Pub. Date: Jan. 25, 2024

(54) SECURING ACCOUNTS OF LAST RESORT

(71) Applicant: Dell Products, L.P., Round Rock, TX (US)

(72) Inventors: Mukund P. Khatri, Austin, TX (US); Senthil Ponnuswamy, San Jose, CA (US); Eugene David Cho, Austin, TX (US)

(73) Assignee: Dell Products, L.P., Round Rock, TX (US)

(21) Appl. No.: 17/813,645

(22) Filed: Jul. 20, 2022

(51) Int. Cl. H04L 9/32; H04L 9/08

(52) U.S. Cl. CPC H04L 9/3263; H04L 9/3247; H04L 9/0866

(57) ABSTRACT

Systems and methods for securing Accounts of Last Resort (ALRs) are described. In an illustrative, non-limiting embodiment, an IHS may include a processor and a memory coupled to the processor, the memory having program instructions that, upon execution, cause the IHS to receive a credential from one of a plurality of users to log onto an ALR, where the credential is shared among the plurality of users, and log the user onto the ALR in response to verification of a signed digital certificate provided by the user.

### FIELD

This disclosure relates generally to Information Handling Systems, and, more specifically, to systems and methods for securing Accounts of Last Resort.

### BACKGROUND

As the value and use of information continues to increase, individuals and businesses seek additional ways to process and store it. One option available to users is an Information Handling System (IHS). An IHS generally processes, compiles, stores, and/or communicates information or data for business, personal, or other purposes thereby allowing users to take advantage of the value of the information. Because technology and information handling needs and requirements vary between different users or applications, IHSs may also vary regarding what information is handled, how the information is handled, how much information is processed, stored, or communicated, and how quickly and efficiently the information may be processed, stored, or communicated.

Variations in IHSs allow for IHSs to be general or configured for a specific user or specific use such as financial transaction processing, airline reservations, enterprise data storage, or global communications. In addition, IHSs may include a variety of hardware and software components that may be configured to process, store, and communicate information and may include one or more computer systems, data storage systems, and networking systems.

### SUMMARY

Systems and methods for securing Accounts of Last Resort (ALRs) are described. In an illustrative, non-limiting embodiment, an IHS may include a processor and a memory coupled to the processor, the memory having program instructions stored thereon that, upon execution, cause the IHS to receive a credential from one of a plurality of users to log onto an ALR, where the credential is shared among the plurality of users, and log the user onto the ALR in response to verification of a signed digital certificate provided by the user.

In some cases, the credential may include a password. The ALR may be distinct from any other account uniquely provisioned for any of the plurality of users. The program instructions, upon execution, may cause the IHS to, prior to the verification: generate a digital certificate; sign the digital certificate using a private encryption key unique to the IHS; and deliver a copy of the signed digital certificate to the user.

To generate the digital certificate, the program instructions, upon execution, may cause the IHS to receive a certificate signing request (CSR) from the user. The program instructions, upon execution, may cause the IHS to deliver another private encryption key to the user along with the signed digital certificate.

The program instructions, upon execution, may cause the IHS to generate the private encryption key based, at least in part, upon information unique to the IHS. Additionally, or alternatively, the program instructions, upon execution, may cause the IHS to generate the private encryption key based, at least in part, upon another encryption key usable to perform verification of a hardware component of the IHS.

Additionally, or alternatively, the program instructions, upon execution, further cause the IHS to generate the private encryption key based, at least in part, upon another encryption key usable to perform verification of a firmware component of the IHS. Additionally, or alternatively, the program instructions, upon execution, may cause the IHS to generate the private encryption key based, at least in part, upon another encryption key usable to perform verification of a software component of the IHS.

To log the user onto the ALR in response to verification of the signed digital certificate, the program instructions, upon execution, may cause the IHS to prove possession of another private encryption key that is paired to a public encryption key in the signed digital certificate. Additionally, or alternatively, to log the user onto the ALR in response to verification of the signed digital certificate, the program instructions, upon execution, may cause the IHS to log the user onto the ALR if the signed digital certificate is stored in a storage device external to the IHS.

Additionally, or alternatively, to log the user onto the ALR in response to verification of the signed digital certificate, the program instructions, upon execution, may cause the IHS to log the user onto the ALR if a button on a chassis of the IHS is pushed. Additionally, or alternatively, to log the user onto the ALR in response to verification of the signed digital certificate, the program instructions, upon execution, further cause the IHS to log the user onto the ALR if the user provides a matching service tag of the IHS or a public encryption key usable to perform verification of a component of the IHS.

In another illustrative, non-limiting embodiment, a method may include: receiving a request, at an IHS, to provision a unique instance of a shared account, where a password usable to log onto the shared account is shared among a plurality of users; signing a digital certificate with a private encryption key unique to the IHS; and delivering the signed digital certificate to a user. The method may also include generating the private encryption key based, at least in part, upon another encryption key usable to perform verification of a component of the IHS. The method may further include logging the user onto the shared account in response to verification of a copy of the signed digital certificate received from the user.

In another illustrative, non-limiting embodiment, a memory storage device may have program instructions stored thereon that, upon execution by an IHS, cause the IHS to: receive a request to provision a unique instance of a shared account, where a password usable to log onto the shared account is shared among a plurality of users; sign a digital certificate with a private encryption key created based, at least in part, upon an encryption key usable to perform verification of a component of the IHS; and deliver the signed digital certificate to a user.

The digital certificate may include a public encryption key paired to another private encryption key that belongs to the user. The program instructions, upon execution, may cause the IHS to log the user onto the shared account in response to verification of a copy of the signed digital certificate received from the user.

### BRIEF DESCRIPTION OF THE DRAWINGS

The present invention(s) is/are illustrated by way of example and is/are not limited by the accompanying figures, in which like references indicate similar elements. Elements in the figures are illustrated for simplicity and clarity and have not necessarily been drawn to scale.

FIG. 1 depicts a diagram of examples of components of an Information Handling System (IHS), according to some embodiments.

FIG. 2 depicts a diagram of a system for securing Accounts of Last Resort (ALRs), according to some embodiments.

FIG. 3 depicts a diagram of an example of a method for securely provisioning an ALR, according to some embodiments.

FIG. 4 depicts a diagram of an example of another method for securely provisioning an ALR, according to some embodiments.

FIG. 5 depicts a diagram of an example of a method for securely logging a user onto an ALR, according to some embodiments.

### DETAILED DESCRIPTION

For purposes of this disclosure, an Information Handling System (IHS) may include any instrumentality or aggregate of instrumentalities operable to compute, calculate, determine, classify, process, transmit, receive, retrieve, originate, switch, store, display, communicate, manifest, detect, record, reproduce, handle, or utilize any form of information, intelligence, or data for business, scientific, control, or other purposes. For example, an IHS may be a personal computer (e.g., desktop or laptop), tablet computer, mobile device (e.g., Personal Digital Assistant (PDA) or smart phone), server (e.g., blade server or rack server), a network storage device, or any other suitable device and may vary in size, shape, performance, functionality, and price.

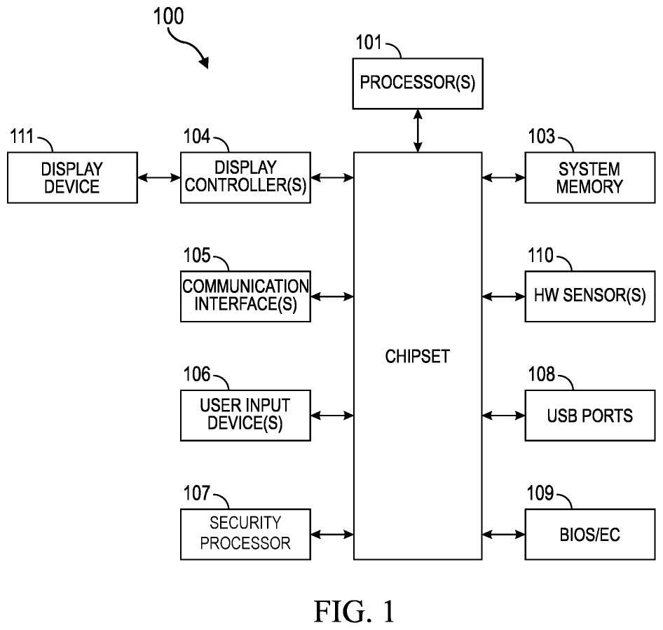

An IHS may include random access memory (RAM), one or more processing resources such as a central processing unit (CPU) or hardware or software control logic, ROM, and/or other types of nonvolatile memory. Additional components of an IHS may include one or more disk drives, one or more network ports for communicating with external devices as well as various input and output (I/O) devices, such as a keyboard, a mouse, touchscreen and/or a video display. An IHS may also include one or more buses operable to transmit communications between the various hardware components. A more detailed example of an IHS is described with respect to FIG. 1. It should be appreciated that although certain embodiments are discussed in the context of a personal computing device, other embodiments may utilize other types of IHSs.

As used herein, the term “user account” (or “account”) refers to an identity maintained for a user of an IHS. In many cases, to operate an IHS, a user may be required to provide logon credentials that verify, attest, or confirm their ownership or assignment of a particular user account. For example, upon the booting of an IHS, a user may be asked to enter a username and password to log onto a user account maintained by an Operating System (OS) of the IHS.

In enterprise deployments there may be different types of user accounts. For instance, “administrator accounts” may provide users with privileges necessary to perform administrative tasks on an IHS, such as the installation of new hardware or software applications. Conversely, “personal accounts” provides each user with privileges individually granted to them, which are usually more restrictive than administrator privileges. A third type of account known as a “guest account” is an anonymous user account that provides any user access to an IHS on a limited or temporary basis.

Yet another type of user account, referred to herein as an “emergency account,” a “glass break account,” or an “Account of Last Resort” (ALR), is intended as a last resort for a user to gain access to an IHS that is not otherwise accessible, for example, because of account, authentication, and/or authorization problems (e.g., when a helpdesk or system administrator is unavailable, there is an ongoing ransomware attack, etc.). In some emergency situations, ALR access may be sought as an alternative to personal, administrative, or guest user account access.

Across an enterprise, a single ALR is often usable by many users on many IHSs, such that logon credentials for the ALR are shared among those users (e.g., same username and password). The inventors hereof have recognized, however, that if shared ALR logon credentials are compromised, multiple IHSs can become vulnerable. To address these, and other concerns, systems and methods for securing ALRs are described herein.

FIG. 1 is a block diagram of components of IHS 100, according to some embodiments. As depicted, IHS 100 includes processor 101. In various embodiments, IHS 100 may be a single-processor system, or a multi-processor system including two or more processors. Processor 101 may include any processor capable of executing program instructions, such as a PENTIUM series processor, or any general-purpose or embedded processors implementing any of a variety of Instruction Set Architectures (ISAs), such as an x86 ISA or a Reduced Instruction Set Computer (RISC) ISA (e.g., POWERPC, ARM, SPARC, MIPS, etc.).

IHS 100 includes chipset 102 coupled to processor 101. Chipset 102 may provide processor 101 with access to several resources. In some cases, chipset 102 may utilize a QuickPath Interconnect (QPI) bus to communicate with processor 101. Chipset 102 may also be coupled to communication interface(s) 105 to enable communications between IHS 100 and various wired and/or wireless networks, such as Ethernet, WiFi, BT, cellular or mobile networks (e.g., code-division multiple access or “CDMA,” time-division multiple access or “TDMA,” Long-Term Evolution or “LTE,” etc.), satellite networks, or the like. In some cases, communication interface(s) 105 may be used to communicate with devices (e.g., BT speakers, microphones, headsets, etc.). Moreover, interface(s) 105 may be coupled to chipset 102 via a Peripheral Component Interconnect Express (PCIe) bus.

Chipset 102 may be coupled to display controller(s) 104, which may include one or more or graphics processor(s) (GPUs) on a graphics bus, such as an Accelerated Graphics Port (AGP) or PCIe bus. As shown, display controller(s) 104 provide video or display signals to display device 111. In other implementations, any number of display controllers or display devices may be used.

Display device 111 may include Liquid Crystal Display (LCD), Light Emitting Diode (LED), organic LED (OLED), or other thin film display technologies. Display device 111 may include a plurality of pixels arranged in a matrix, configured to display visual information, such as text, two-dimensional images, video, three-dimensional images, etc. In some cases, display device 111 may be provided as a single continuous display, rather than two discrete displays.

Chipset 102 may provide processor 101 and/or display controller(s) 104 with access to system memory 103. In various embodiments, system memory 103 may be implemented using any suitable memory technology, such as static RAM (SRAM), dynamic RAM (DRAM) or magnetic disks, or any nonvolatile/Flash-type memory, such as a solid-state drive (SSD) or the like. Memory 103 may store program instructions that, upon execution by processor 101, enable a collaboration mode for a touchpad coupled or integrated into IHS 100.

Chipset 102 may provide components of IHS 100 (e.g., processor(s) 101) with access to security processor 107. In various embodiments, security processor 107 may include a chip or core dedicated to providing encryption or other security operations to IHS 100. For example, security processor 107 may include a Trusted Platform Module (TPM) configured to securely store encryption keys and measurements that help verify the integrity of IHS 100. Additionally, or alternatively, a TPM-like architecture of security processor 107 may be integrated, in a secure manner, into processor(s) 101, EC 109, a Baseband Management Controller (BMC), a storage controller, etc. Other examples of security processor(s) 107 include, but are not limited to: AMD's PLATFORM SECURITY PROCESSOR (PSP), MICROSOFTS's PLUTON, INTEL's CONVERGED SECURITY AND MANAGEMENT ENGINE (CSME), etc.

In some embodiments, security processor 107 may include registers, such as platform configuration registers (PCRs), and secure storage, such as a Non-Volatile Random-Access Memory (NVRAM). Security processor 107 may also include a cryptographic processor that supports various cryptographic capabilities. For example, a pre-boot process implemented by security processor 107 may utilize its cryptographic capabilities to calculate hash values that are based on software and/or firmware instructions utilized by certain core components of IHS 100. These calculated hash values may then be compared against reference hash values that were previously stored in a secure non-volatile memory, such as during factory provisioning of IHS 100. In this manner, security processor 107 may establish a root of trust that includes core components of IHS 100 validated as operating using instructions that originate from a trusted source.

In some embodiments, chipset 102 may also provide access to one or more hard drives, solid state drives, optical drives, or other removable-media drives. In certain embodiments, chipset 102 may also provide access to one or more Universal Serial Bus (USB) ports 108, to which one or more peripheral devices may be coupled (e.g., internal or external webcams, microphones, speakers, etc.).

Chipset 102 may further provide access to one or more user input devices 106, for example, using a super I/O controller or the like. Examples of user input devices 106 include, but are not limited to, a keyboard, mouse, touchpad, stylus or active pen, totem, etc. Each of user input devices 106 may include a respective controller (e.g., a touchpad may have its own touchpad controller) that interfaces with chipset 102 through a wired or wireless connection (e.g., via communication interfaces(s) 105).

In certain embodiments, chipset 102 may also provide an interface for communications with one or more hardware (HW) sensors 110. Sensors 110 may be disposed on or within the chassis of IHS 100, or otherwise coupled to IHS 100, and may include, but are not limited to: electric, magnetic, radio, optical (e.g., camera, webcam, etc.), infrared, thermal, force, pressure, acoustic, ultrasonic, proximity, position, deformation, bending, direction, movement, velocity, rotation, and/or acceleration sensor(s).

Upon booting of IHS 100, processor(s) 101 may utilize Basic Input/Output System (BIOS) instructions of BIOS/Embedded Controller (EC) 109 to initialize and test hardware components coupled to IHS 100 and to load an OS for use by IHS 100. BIOS 109 provides an abstraction layer that allows the OS to interface with certain hardware components that are utilized by IHS 100. Via the hardware abstraction layer provided by BIOS 109, software stored in system memory 103 and executed by processor 101 can interface with certain I/O devices that are coupled to IHS 100. The Unified Extensible Firmware Interface (UEFI) was designed as a successor to BIOS. As a result, many modern IHSs utilize UEFI in addition to or instead of a BIOS. As used herein, BIOS 109 is intended to also encompass a UEFI component.

EC 109 may be installed as a Trusted Execution Environment (TEE) component to the motherboard of IHS 100. EC 109 may implement operations for interfacing with a power adapter in managing power for IHS 100. Such operations may be utilized to determine the power status of IHS 100, such as whether IHS 100 is operating from battery power or is plugged into an AC power source. Firmware instructions utilized by EC 109 may be used to provide various core operations of IHS 100, such as power management and management of certain modes of IHS 100 (e.g., turbo modes, maximum operating clock frequencies of certain components, etc.).

In some implementations, a low-power mode of operation may include the S0 low-power idle model, also known as Modern Standby or Connected Standby, which provides an instant on/off user experience and maintains a network connection for certain processes while consuming very little power. These power modes may be entered, for example, when IHS 100 transitions into standby (e.g., “sleep,” etc.).

EC 109 may also implement operations for detecting certain changes to the physical configuration or posture of IHS 100 and managing the modes of a touchpad or other user input device 106 in different configurations of IHS 100. For instance, where IHS 100 as a 2-in-1 laptop/tablet form factor, EC 109 may receive inputs from a lid position or hinge angle sensor 110, and it may use those inputs to determine: whether the two sides of IHS 100 have been latched together to a closed position or a tablet position, the magnitude of a hinge or lid angle, etc.

EC 109 may be further configured to calculate hashes or signatures that uniquely identify individual components of IHS 100. In such scenarios, EC 109 may calculate a hash value based on the configuration of a hardware and/or software component coupled to IHS 100. For instance, EC 109 may calculate a hash value based on all firmware and other code or settings stored in an onboard memory of a hardware component. Such hash values may be calculated as part of a trusted process of manufacturing IHS 100 and may be maintained in secure storage as a reference signature. EC 109 may later recalculate the hash value for a component may compare it against the reference hash value to determine if any modifications have been made to the component, thus indicating that the component has been compromised. In this manner, EC 109 may validate the integrity of hardware and software components installed on IHS 100.

In some embodiments, IHS 100 may not include all the components shown in FIG. 1. In other embodiments, IHS 100 may include other components in addition to those that are shown in FIG. 1. Furthermore, some components that are represented as separate components in FIG. 1 may instead be integrated with other components. For example, all or a portion of the operations executed by the illustrated components may instead be executed by components integrated into processor(s) 101 as systems-on-a-chip (SoC). As such, in various embodiments, IHS 100 may be implemented as different classes of computing devices including, but not limited to: servers, workstations, desktops, laptops, appliances, video game consoles, tablets, smartphones, etc.

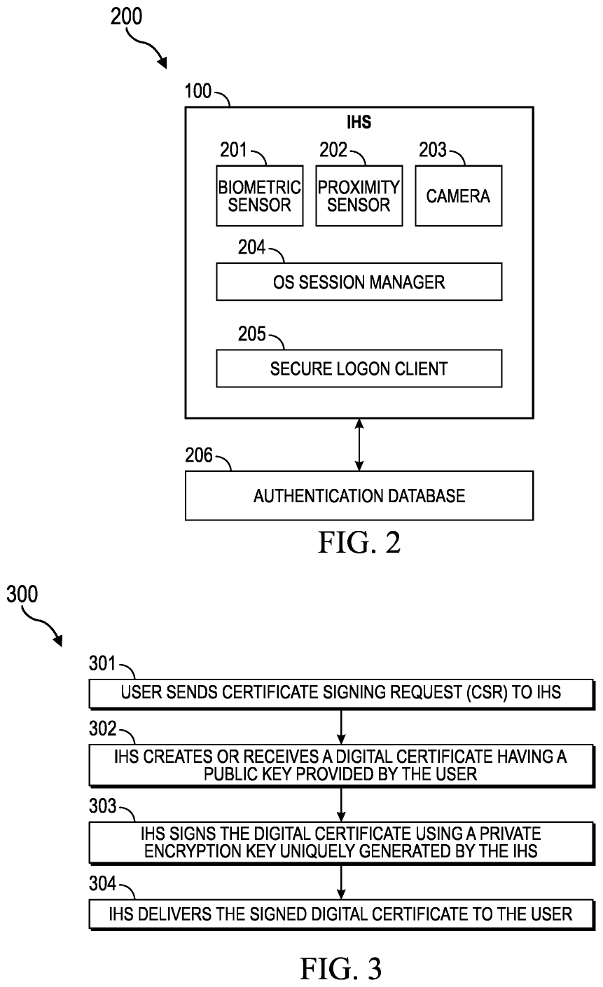

FIG. 2 illustrates a diagram of system 200 for securing ALRs. In some embodiments, components of system 200 may be instantiated, at least in part, through the execution of program instructions stored in a memory device (e.g., system memory 103) by a processor (e.g., processor(s) 101) of IHS 100. Particularly, IHS 100 includes biometric sensor 201, proximity sensor 202, camera device 203 (e.g., hardware sensors 110), session managed OS 204, and secure logon client 205. System 200 may also include authentication database 206 as part of IHS 100 or in communication therewith.

In operation, OS session manager 204 manages user environments on IHS 100. For example, OS session manager 204 may represent an OS that enables a user of IHS 100 to be logged onto IHS 100, thereby creating a session for the user logged onto IHS 110. An example of an OS may include a Linux OS, a Unix OS, a Remote Desktop Connection enabled Windows Server OS, a multi-user OS, etc. In other embodiments, OS session manager 204 may include a Virtual Machine (VM) hypervisor or environment. Examples of VM environments include, but are not limited to: VMware, Xen, Hyper-V, etc.

Secure logon client 205 performs user authentication processes. In operation, secure logon client 205 receives logon credentials from the user of IHS 100 and authenticates those logon credentials against stored authentication data. Upon authentication of the user, secure logon client 205 directs OS session manager 204 to establish a session allocated to that user.

In some embodiments, a user may log onto IHS 100 using a traditional personal or administrative user account. Particularly, a user may provide logon credentials to secure logon client 205 using a keyboard or a keypad (e.g., user input device(s) 106). IHS 100 may provide a prompt to the user, the user may type in the logon credentials, and secure logon client 205 may compare the input data with stored data to authenticate the user. For example, secure logon client 205 may authenticate the user onto IHS 100 by comparing typed logon credentials with information from authentication database 206. Typed logon credentials may include, but are not limited to: a username, a password, a Personal Identification Number (PIN), etc.

As another example, a user may provide logon credentials to secure logon client 205 via biometric sensor 201. IHS 100 may provide a prompt to the user to provide logon credentials, the user may provide a scan of a particular biometric aspect of their person, and secure logon client 205 may compare the scan with stored data to authenticate the user. For instance, secure logon client 205 may authenticate the user onto IHS 100 by comparing the data from the scan with information from authentication database 206. Biometric logon credentials may include, but are not limited to: fingerprint scans, retinal scans, facial scans, body scans, voice scans, etc.

In yet another example, secure logon client 205 may capture a visual image of a user with camera 203, and it may authenticate the user onto a session by comparing the image with pictures or the user (and/or other users) stored in authentication database 206.

In still another example, a user may provide logon credentials to secure logon client 205 via proximity sensor 202. IHS 100 may detect the presence of a secure device, such as a Smart Card, a Near Field Communication (NFC) device, a Smart Phone with an associated logon application, a Radio Frequency Identification (RFID) tag, it may compare data from the secure device with associated user data, and it may authenticate that user onto IHS 100. For instance, secure logon client 205 may authenticate the user onto IHS 100 by comparing the secure device logon credentials with information from authentication database 206.

Authentication database 206 represents a repository for the creation and storage of logon credentials. New users may proceed through a registration or provisioning procedure where authentication information for the user is originally created and stored. For example, with respect to personal user accounts, each user can be given a username/password pair, biometric data can be gathered, such as a fingerprint scan, a retinal scan, a voice sample, or the like, facial recognition information such as a photograph can be taken, and/or the user can be handed a secure authentication device. In some implementations, authentication database 206 may be included in secure logon client 205. Additionally, or alternatively, at least a portion of authentication database 206 may be accessible to IHS 100 via a network connection.

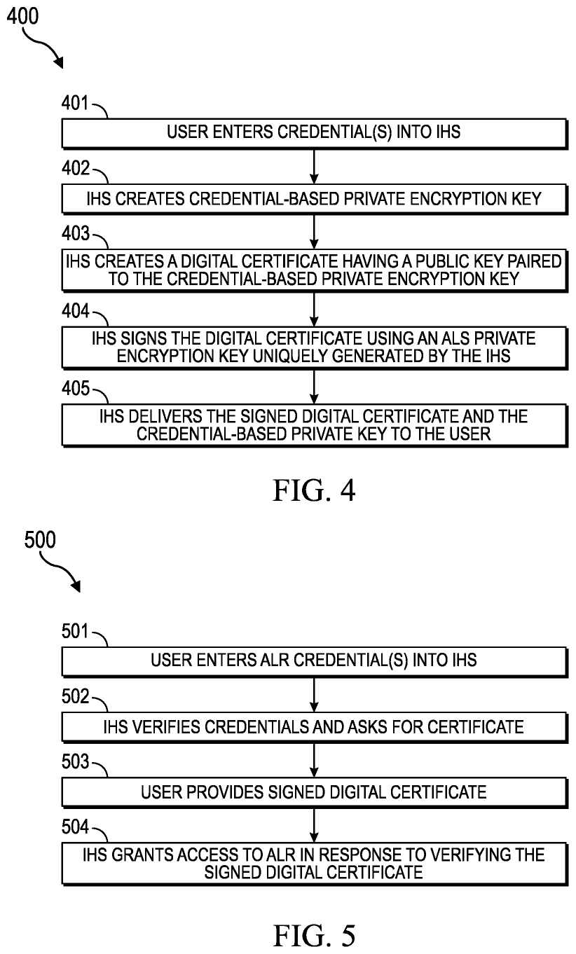

Additionally, or alternatively, secure logon client 205 may allow a user to securely log onto an ALR with logon credentials that are shared among a plurality of users, as described in more detail with respect to FIG. 5. The secure provisioning of ALR accounts for each user by secure logon client 205, in a manner that is unique to each IHS in an enterprise (despite shared logon credentials), is described in more detail below with respect to FIGS. 3 and 4. After provisioning, FIG. 5 shows an example of a ALR account logon process.

FIG. 3 depicts a diagram of an example of method 300 for securely provisioning an ALR. In some embodiments, one or more operations of method 300 may be executed, at least in part, by one or more components of system 200, as instantiated by IHS 100.

Before method 300 starts at 301, a user of IHS 100 may have generated a user encryption key pair including a private user encryption key and a public user encryption key, with any suitable Key Derivation Function (KDF). The private user encryption key may be kept secret (e.g., in a trust store). Then, at 301, the user sends or otherwise initiates a Certificate Signing Request (CSR) to secure logon client 205 for generating a digital certificate that includes the public user encryption key. In some respects, the user may treat IHS 100 as a Public Key Infrastructure (PKI) Certificate Authority (CA) when they apply for such a digital certificate.

At 302, secure logon client 205 may create or receive a digital certificate that includes the user public encryption key, originally included in the CSR. Moreover, prior to 303, secure logon client 205 may have produced an ALR encryption key pair including an ALR private encryption key and an ALR public encryption key, with any suitable KDF. Unlike the user encryption key pair, however, the ALR encryption key pair created by secure logon client 205 may be generated, at least in part, based upon seed data that is unique to IHS 100. At least in part because the seed data used by secure logon client 205 is specific to IHS 100, ALR encryption keys are uniquely generated by IHS 100.

Examples of seed data unique to IHS 100 may include, but are not limited to, other encryption keys, other digital certificates, or device IDs usable by secure logon client 205 to perform verification of hardware, firmware, or software components of IHS 100. In some cases, these other digital certificates may contain a unique manifest of IHS component IDs generated during the factory assembly of IHS 100. Additional KDF inputs that are unique to IHS 100 may include, but are not limited to: a service tag or serial number of IHS 100, a Media Access Control (MAC) address of IHS 100, a physical location of IHS 100, a network address of IHS 100, etc.

At 303, secure logon client 205 signs the digital certificate using the ALR private encryption key. At 304, secure logon client 205 delivers the signed digital certificate to the user, for example, for subsequent safekeeping in a trust store. As described with respect to FIG. 5, to securely log onto an ALR account in IHS 100 later on, a user may be requested to provide a copy of the signed digital certificate produced by that same IHS 100 and delivered to them at 304.

FIG. 4 depicts a diagram of an example of method 400 for securely provisioning an ALR. In some embodiments, one or more operations of method 400 may be executed, at least in part, by one or more components of system 200, as instantiated by IHS 100.

Method 400 begins at 401 where a user of IHS 100 enters one or more ALR logon credentials (e.g., password, fingerprint, etc. usable to log onto an ALR account) into secure logon client 205. At 402, secure logon client 205 creates a credential-based encryption key pair using the logon credentials of 401 as seed data into a KDF (i.e., instead of IHS-specific component verification keys). The credential-based encryption key pair may include a private credential encryption key and a public credential encryption key. At 403, secure logon client 205 creates a digital certificate containing the public credential encryption key.

Similarly as in method 300, prior to 404 secure logon client 205 may also generate an ALR encryption key pair including a private ALR encryption key and a public ALR encryption key. Then, at 404, secure logon client 205 may sign the digital certificate with the private ALR encryption key. At 405, secure logon client 205 may deliver a copy of the signed digital certificate and the private credential encryption key to the user for safekeeping.

Accordingly, as part of the provisioning operations of methods 300 and/or 400, when a user triggers ALR account creation, IHS 100 may request ALR logon credentials (e.g., username and password for ALR account), the user may enter the ALR logon credentials, and, in response, IHS 100 may return to the user a unique-per-IHS, signed digital certificate (and, optionally, a private credential encryption key).

The user may store the signed digital certificate (and private credential encryption key) for later use, for example, in emergency situations (e.g., the user's personal and/or administrative accounts are not working because a multi-factor authentication, Single Sign-On, or Lightweight Directory Access Protocol service is down, etc.). Even in such situations, the user may still securely log onto an ALR account using the signed digital certificate received during provisioning (and private user or credential encryption key(s)).

FIG. 5 depicts a diagram of an example of method 500 for securely logging a user onto an ALR. In some embodiments, one or more operations of method 500 may be executed, at least in part, by one or more components of system 200, as instantiated by IHS 100.

Method 500 begins at 501, when a user enters shared, ALR logon credentials into secure logon client 205 of IHS 100. At 502, secure logon client 205 verifies the ALR logon credentials (e.g., against authentication database 206) and prompts the user for a digital certificate (e.g., via a Graphical User Interface or “GUI,” Command Line Interface or “CLI,” etc.).

At 503, the user provides the signed digital certificate received at 304 or 405. Then, at 504, secure logon client 205 grants the user access to the ALR account in response to a successful verification of the signed digital certificate (e.g., using a public ALR encryption key paired to the private ALR encryption key used to sign the certificate at 303 or 404 and/or by comparing the public encryption key in the digital certificate against a derived ALR public encryption key).

In some cases, in addition to verifying the digital certificate, secure logon client 205 may also request that the user prove possession of a private user or credential encryption key corresponding to the public key in the digital certificate. Secure logon client 205 may also log the user onto the ALR if (or only if): the signed digital certificate is stored in a storage device external to IHS 100 (e.g., a USB drive), a button on a chassis of IHS 100 is pushed (e.g., within a time window, for a certain duration, a number of times, etc.), the user provides a random-per-IHS token code or unique default password, or the user provides a matching service tag of IHS 100 or a public encryption key or ID usable to perform verification of a component of IHS 100.

As such, systems and methods described herein promote the secure use of ALR accounts with a single username and password combination (or other logon credential) shared across multiple IHSs and users. These systems and methods may reduce, minimize, or eliminate enterprise-wide, credential risk exposure.

Moreover, various techniques for ALR certificate-based authentication described herein may scale rapidly and in a scriptable manner across a datacenter to reduce errors. In some cases, these systems and methods may support multiple ALR accounts concurrently in an enterprise and may be expanded to other user-owned keys.

In other cases, aspects of the systems and methods described herein may be combined with role-based access controls, for example, so that an ALR user is the only user of IHS 100 allowed to have highest and/or infrequently granted privileges. Furthermore, an ALR digital certificate as described herein may support an enterprise's key management practices or policies, including revocation, rotation, expiry, etc.

In many implementations, systems and methods described herein may be incorporated into a wide range of electronic devices including, for example, computer systems or Information Technology (IT) products such as servers, desktops, laptops, memories, switches, routers, etc.; telecommunications hardware; consumer devices or appliances such as mobile phones, tablets, wearable devices, IoT devices, television sets, cameras, sound systems, etc.; scientific instrumentation; industrial robotics; medical or laboratory electronics such as imaging, diagnostic, or therapeutic equipment, etc.; transportation vehicles such as automobiles, buses, trucks, trains, watercraft, aircraft, etc.; military equipment, etc. More generally, these systems and methods may be incorporated into any device or system having one or more electronic parts or components.

To implement various operations described herein, computer program code (i.e., program instructions for carrying out these operations) may be written in any combination of one or more programming languages, including an object-oriented programming language such as Java, Smalltalk, Python, C++, or the like, conventional procedural programming languages, such as the “C” programming language or similar programming languages, or any of machine learning software. These program instructions may also be stored in a computer readable storage medium that can direct a computer system, other programmable data processing apparatus, controller, or other device to operate in a particular manner, such that the instructions stored in the computer readable medium produce an article of manufacture including instructions which implement the operations specified in the block diagram block or blocks. The program instructions may also be loaded onto a computer, other programmable data processing apparatus, controller, or other device to cause a series of operations to be performed on the computer, or other programmable apparatus or devices, to produce a computer implemented process such that the instructions upon execution provide processes for implementing the operations specified in the block diagram block or blocks.

Modules implemented in software for execution by various types of processors may, for instance, include one or more physical or logical blocks of computer instructions, which may, for instance, be organized as an object or procedure. Nevertheless, the executables of an identified module need not be physically located together but may include disparate instructions stored in different locations which, when joined logically together, include the module and achieve the stated purpose for the module. Indeed, a module of executable code may be a single instruction, or many instructions, and may even be distributed over several different code segments, among different programs, and across several memory devices. Similarly, operational data may be identified and illustrated herein within modules and may be embodied in any suitable form and organized within any suitable type of data structure. The operational data may be collected as a single data set or may be distributed over different locations including over different storage devices.

Reference is made herein to “configuring” a device or a device “configured to” perform some operation(s). It should be understood that this may include selecting predefined logic blocks and logically associating them. It may also include programming computer software-based logic of a retrofit control device, wiring discrete hardware components, or a combination of thereof. Such configured devices are physically designed to perform the specified operation(s).

It should be understood that various operations described herein may be implemented in software executed by processing circuitry, hardware, or a combination thereof. The order in which each operation of a given method is performed may be changed, and various operations may be added, reordered, combined, omitted, modified, etc. It is intended that the invention(s) described herein embrace all such modifications and changes and, accordingly, the above description should be regarded in an illustrative rather than a restrictive sense.

Unless stated otherwise, terms such as “first” and “second” are used to arbitrarily distinguish between the elements such terms describe. Thus, these terms are not necessarily intended to indicate temporal or other prioritization of such elements. The terms “coupled” or “operably coupled” are defined as connected, although not necessarily directly, and not necessarily mechanically. The terms “a” and “an” are defined as one or more unless stated otherwise. The terms “comprise” (and any form of comprise, such as “comprises” and “comprising”), “have” (and any form of have, such as “has” and “having”), “include” (and any form of include, such as “includes” and “including”) and “contain” (and any form of contain, such as “contains” and “containing”) are open-ended linking verbs. As a result, a system, device, or apparatus that “comprises,” “has,” “includes” or “contains” one or more elements possesses those one or more elements but is not limited to possessing only those one or more elements. Similarly, a method or process that “comprises,” “has,” “includes” or “contains” one or more operations possesses those one or more operations but is not limited to possessing only those one or more operations.

Although the invention(s) is/are described herein with reference to specific embodiments, various modifications and changes can be made without departing from the scope of the present invention(s), as set forth in the claims below. Accordingly, the specification and figures are to be regarded in an illustrative rather than a restrictive sense, and all such modifications are intended to be included within the scope of the present invention(s). Any benefits, advantages, or solutions to problems that are described herein with regard to specific embodiments are not intended to be construed as a critical, required, or essential feature or element of any or all the claims.

1. An Information Handling System (IHS), comprising:
a processor; and
a memory coupled to the processor, the memory having program instructions stored thereon that, upon execution, cause the IHS to:
receive a credential from one of a plurality of users to log onto an Account of Last Resort (ALR), wherein the credential is shared among the plurality of users; and
log the user onto the ALR in response to verification of a signed digital certificate provided by the user.

2. The IHS of claim 1, wherein the credential comprises a password.

3. The IHS of claim 1, wherein the ALR is distinct from any other account uniquely provisioned for any of the plurality of users.

4. The IHS of claim 1, wherein the program instructions, upon execution, further cause the IHS to, prior to the verification:
generate a digital certificate;
sign the digital certificate using a private encryption key unique to the IHS; and
deliver a copy of the signed digital certificate to the user.

5. The IHS of claim 4, wherein to generate the digital certificate, the program instructions, upon execution, further cause the IHS to receive a certificate signing request (CSR) from the user.

6. The IHS of claim 4, wherein the program instructions, upon execution, further cause the IHS to deliver another private encryption key to the user along with the signed digital certificate.

7. The IHS of claim 4, wherein the program instructions, upon execution, further cause the IHS to generate the private encryption key based, at least in part, upon information unique to the IHS.

8. The IHS of claim 4, wherein the program instructions, upon execution, further cause the IHS to generate the private encryption key based, at least in part, upon another encryption key usable to perform verification of a hardware component of the IHS.

9. The IHS of claim 4, wherein the program instructions, upon execution, further cause the IHS to generate the private encryption key based, at least in part, upon another encryption key usable to perform verification of a firmware component of the IHS.

10. The IHS of claim 4, wherein the program instructions, upon execution, further cause the IHS to generate the private encryption key based, at least in part, upon another encryption key usable to perform verification of a software component of the IHS.

11. The IHS of claim 4, wherein to log the user onto the ALR in response to verification of the signed digital certificate, the program instructions, upon execution, further cause the IHS to prove possession of another private encryption key that is paired to a public encryption key in the signed digital certificate.

12. The IHS of claim 4, wherein to log the user onto the ALR in response to verification of the signed digital certificate, the program instructions, upon execution, further cause the IHS to log the user onto the ALR if the signed digital certificate is stored in a storage device external to the IHS.

13. The IHS of claim 4, wherein to log the user onto the ALR in response to verification of the signed digital certificate, the program instructions, upon execution, further cause the IHS to log the user onto the ALR if a button on a chassis of the IHS is pushed.

14. The IHS of claim 4, wherein to log the user onto the ALR in response to verification of the signed digital certificate, the program instructions, upon execution, further cause the IHS to log the user onto the ALR if the user provides a matching service tag of the IHS or a public encryption key usable to perform verification of a component of the IHS.

15. A method, comprising:
receiving a request, at an Information Handling System (IHS), to provision a unique instance of a shared account, wherein a password usable to log onto the shared account is shared among a plurality of users;
signing a digital certificate with a private encryption key unique to the IHS; and
delivering the signed digital certificate to a user.

16. The method of claim 15, further comprising:
generating the private encryption key based, at least in part, upon another encryption key usable to perform verification of a component of the IHS.

17. The method of claim 15, further comprising logging the user onto the shared account in response to verification of a copy of the signed digital certificate received from the user.

18. A memory storage device having program instructions stored thereon that, upon execution by an Information Handling System (IHS), cause the IHS to:
receive a request to provision a unique instance of a shared account, wherein a password usable to log onto the shared account is shared among a plurality of users;
sign a digital certificate with a private encryption key created based, at least in part, upon an encryption key usable to perform verification of a component of the IHS; and
deliver the signed digital certificate to a user.

19. The memory storage device of claim 18, wherein the digital certificate comprises a public encryption key paired to another private encryption key that belongs to the user.

20. The memory storage device of claim 18, wherein the program instructions, upon execution, further cause the IHS to log the user onto the shared account in response to verification of a copy of the signed digital certificate received from the user.
